(19) United States
(12) Patent Application Publication
(10) Pub. No.: US 2022/0032689 A1
(43) Pub. Date: Feb. 3, 2022

(54) Hooping Reinforcement for a Tire of a Heavy Duty Civil Engineering Vehicle

(71) Applicant: COMPAGNIE GENERALE DES ETABLISSEMENTS MICHELIN, Clermont - Ferrand (FR)

(72) Inventors: Elodie LE CHENADEC, Clermont - Ferrand Cedex 9 (FR); Cédric KHAYAT, Clermont - Ferrand Cedex 9 (FR)

(21) Appl. No.: 17/276,024

(22) PCT Filed: Sep. 5, 2019
(86) PCT No.: PCT/EP2019/073739

§ 371 Date: Mar. 12, 2021

(30) Foreign Application Priority Data
Sep. 13, 2018 (FR) 1858200

(51) Int. Cl. B60C 9/22; B60C 9/20

(52) U.S. Cl. CPC B60C 9/2204; B60C 9/2006; B60C 2009/2016; B60C 2009/2019; B60C 2009/2035; B60C 2009/2041; B60C 2009/209; B60C 2009/2083; B60C 2009/2223; B60C 2009/2257; B60C 2009/2266; B60C 2200/065; B60C 2009/2276; B60C 2009/2077

(57) ABSTRACT

Improve endurance of tire for heavy-duty vehicle of construction plant type. A hoop reinforcement has an axially continuous first hooping layer and axially discontinuous second hooping layer, first layer has an axial width LF1 at least equal to 25% and at most 75% of axial width LT of working reinforcement, the discontinuous second hooping layer consists of two hooping strips symmetrical with respect to equatorial plane (XZ) of tire, each extends axially from axially interior end as far as axially exterior end over an axial width LF2 which is at least equal to 10% and at most 35% of axial width LF1 of the first hooping layer, and the distributed tension at break TR of each hooping strip defined as the product of number D of reinforcers per mm times the force at break FR of each reinforcer expressed in daN, is at least equal to 100 daN/mm.

The subject matter of the present invention is a radial tire, intended to be fitted to a heavy-duty vehicle of construction plant type, and more specifically the present invention relates to the crown reinforcement of such a tire.

Typically, a radial tire for a heavy-duty vehicle of construction plant type, within the meaning of the European Tire and Rim Technical Organization or ETRTO standard, is intended to be mounted on a rim with a diameter at least equal to 25 inches. Although not limited to this type of application, the invention is described for a radial tire of large size, which is intended to be mounted on a dumper, a vehicle for transporting materials extracted from quarries or surface mines, by way of a rim with a diameter at least equal to 49 inches, possibly as much as 57 inches, or even 63 inches.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to” and “further away from the axis of rotation of the tire”, respectively. “Axially inner/axially on the inside” and “axially outer/axially on the outside” mean “closer to” and “further away from the equatorial plane of the tire”, respectively, with the equatorial plane of the tire being the plane that passes through the middle of the tread surface and is perpendicular to the axis of rotation.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire further comprises a reinforcement made up of a crown reinforcement radially on the inside of the tread and of a carcass reinforcement radially on the inside of the crown reinforcement.

The carcass reinforcement of a radial tire for a heavy-duty vehicle of construction plant type usually comprises at least one carcass layer comprising generally metal reinforcers coated in a polymeric material of the elastomer or elastomeric type, called coating compound. A carcass layer comprises a main part that joins the two beads together and is generally wound, in each bead, from the inside of the tire to the outside, around a usually metal circumferential reinforcing element known as a bead wire so as to form a turn-up. The metal reinforcers of a carcass layer are substantially mutually parallel and form an angle of between 85° and 95° with the circumferential direction.

The crown reinforcement of a radial tire for a heavy-duty vehicle of construction plant type comprises a superposition of circumferentially extending crown layers, radially on the outside of the carcass reinforcement. Each crown layer is made up of generally metal reinforcers that are mutually parallel and are coated in a polymeric material of the elastomer or coating compound type.

Among the crown layers, a distinction is usually made between the protective layers, which make up the protective reinforcement and are radially outermost, and the working layers, which make up the working reinforcement and are comprised radially between the protective reinforcement and the carcass reinforcement.

The protective reinforcement, which comprises at least one protective layer, essentially protects the working layers from mechanical or physicochemical attacks, which are likely to spread through the tread radially towards the inside of the tire.

The protective reinforcement often comprises two protective layers, which are radially superposed, formed of elastic metal reinforcers, are mutually parallel in each layer and are crossed from one layer to the next, forming angles at least equal to 10° with the circumferential direction.

The working reinforcement, comprising at least two working layers, has the function of belting the tire and conferring stiffness and road holding thereon. It absorbs both mechanical inflation stresses, which are generated by the tire inflation pressure and transmitted by the carcass reinforcement, and mechanical stresses caused by running, which are generated as the tire runs over the ground and are transmitted by the tread. It is also intended to withstand oxidation and impacts and puncturing, by virtue of its intrinsic design and that of the protective reinforcement.

The working reinforcement usually comprises two working layers, which are radially overlaid, formed of inextensible metal reinforcers, are mutually parallel in each layer and are crossed from one layer to the next, forming angles at least equal to 15° and at most equal to 60°, and preferably at least equal to 15° and at most equal to 45°, with the circumferential direction.

In order to reduce the mechanical inflation stresses that are transmitted to the working reinforcement, it is known practice to fit a hoop reinforcement radially on the inside of the working reinforcement and radially on the outside of the carcass reinforcement. The hoop reinforcement, the function of which is to at least partially absorb the mechanical inflation stresses, improves the endurance of the crown reinforcement by stiffening the crown reinforcement. The hoop reinforcement also can be positioned radially between two working layers of the working reinforcement or radially on the outside of the working reinforcement.

The hoop reinforcement comprises at least one hooping layer and usually two hooping layers, which are radially overlaid, formed of metal reinforcers, are mutually parallel, and form angles at most equal to 2.5°, and preferably around 0°, with the circumferential direction.

As regards the metal reinforcers, a metal reinforcer is mechanically characterized by a curve representing the tensile force (in N) applied to the metal reinforcer as a function of the relative elongation (in %) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ISO 6892 of 1984.

The total elongation at break At of the metal reinforcer is, by definition, the sum of the structural, elastic and plastic elongations thereof (At=As+Ae+Ap). The structural elongation As results from the relative positioning of the metal threads making up the metal reinforcer under a low tensile force. The elastic elongation Ae results from the actual elasticity of the metal of the metal threads making up the metal reinforcer, taken individually, with the behaviour of the metal following Hooke's law. The plastic elongation Ap results from the plasticity, i.e. the irreversible deformation beyond the yield point, of the metal of these metal threads taken individually. These various elongations and the respective meanings thereof, which are well known to a person skilled in the art, are described, for example, in the documents U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between the elastic metal reinforcers, such as those used in the protective layers, and the inextensible or non-extensible metal reinforcers, such as those used in the working layers.

An elastic metal reinforcer is characterized by a structural elongation As at least equal to 1% and a total elongation at break At at least equal to 4%. Moreover, an elastic metal reinforcer has a tensile elastic modulus at most equal to 150 GPa, and usually between 40 GPa and 150 GPa.

An inextensible metal reinforcer is characterized by a total elongation At, under a tensile force equal to 10% of the force at break Fm, at most equal to 0.2%. Moreover, an inextensible metal reinforcer has a tensile elastic modulus usually between 150 GPa and 200 GPa.

The metal reinforcers are coated in an elastomeric compound. In order to characterize the composite layer, the mechanical properties of the coating compound are normally described.

An elastomeric compound can be mechanically characterized, in particular after curing, by its dynamic properties, such as a dynamic shear modulus G*=(G′²±G″²)^{1/2}, where G′ is the elastic shear modulus and G″ is the viscous shear modulus, and a dynamic loss tan δ=G″IG′. The dynamic shear modulus G* and the dynamic loss tan δ are measured on a viscosity analyser of the Metravib VA4000 type according to standard ASTM D 5992-96. The response of a sample of vulcanized elastomeric compound in the form of a cylindrical test specimen with a thickness of 4 mm and a cross section of 400 mm², subjected to sinusoidal loading in simple alternating shear stress at a frequency of 10 Hz, with a deformation amplitude sweep from 0.1% to 50% (outward cycle) and then from 50% to 0.1% (return cycle), at a given temperature, for example equal to 60° C., is recorded. These dynamic properties are thus measured for a frequency equal to 10 Hz, a deformation equal to 50% of the peak-to-peak deformation amplitude, and a temperature that can be equal to 60° C. or 100° C.

An elastomeric compound can also be characterized by static mechanical properties. The tensile tests make it possible to determine the elasticity stresses and the properties at break. Unless indicated otherwise, they are carried out in accordance with the French standard NF T 46-002 of September 1988. The secant moduli known as “nominal” secant moduli (or apparent stresses, in MPa) at 10% elongation (denoted “MA10”) and 100% elongation (“MA100”) are measured in second elongation (i.e. after an accommodation cycle). All these tensile measurements are carried out under standard temperature (23±2° C.) and hygrometry (50±5% relative humidity) conditions, according to the French standard NF T 40-101 (December 1979). The breaking stresses (in MPa) and the elongations at break (in %) are also measured, at a temperature of 23° C.

Document WO 2016/139348 describes an architecture of a tire for a heavy-duty vehicle of construction plant type as described above and comprising a hoop reinforcement formed by a circumferential winding of a ply comprising circumferential elastic metal reinforcers that make angles at most equal to 2.5° with the circumferential direction, said circumferential winding of the ply extending from a first circumferential end to a second circumferential end radially on the outside of the first circumferential end, so as to form a radial stack of at least two hooping layers, the hoop reinforcement being radially positioned between the two working layers of a working reinforcement.

When manufacturing a tire as described in document WO 2016/139348, the hooping layer is actually a ply comprising elastic metal reinforcers, known as ply of metal reinforcers, and is initially stored on a reel. Then, it is unwound and laid by being circumferentially wound radially on the outside of the tire layers that are already radially stacked. The ply of metal reinforcers is wound over at least two turns so as to produce at least two hooping layers that are radially overlaid, with a circumferential offset between the end at the start of winding and the end at the end of winding such that, over a limited circumferential distance, or length of overlap, the hoop reinforcement comprises three hooping layers. The winding is carried out continuously using a single portion of ply of metal reinforcers. Thus, the hoop reinforcement does not contain any discontinuity. As a result, a portion of ply of metal reinforcers may remain, on the initial storage reel, that is unusable since it is not long enough to produce the hoop reinforcement in one piece. This residual portion of ply of metal reinforcers that is unusable for manufacturing because it is not long enough is also known as waste ply. The existence of such waste plies, which results in a loss of material, has a negative effect on the manufacturing cost of the tire.

An alternative solution for avoiding the loss of material associated with the overlapping of the ends of the plies or with the waste, is to produce a butt weld. These waste plies are attached by bringing together the ends of the two portions to be joined. The space between these two ends is a discontinuity, which is filled with an elastomeric bonding compound that bonds the two portions of ply of metal reinforcers by welding. This is referred to as butt welding in that there is no overlap between the two portions of ply.

In reality, whether the ends of the hooping layers are overlapped or butt-welded, both solutions are detrimental to the uniformity of the tire. Both solutions result in localized overthicknesses which impair the operation of the tire by creating bounce as the tire runs. The cost of manufacture is also adversely affected by the resultant loss of material.

The product overthicknesses also have negative impacts on the endurance of the tire by increasing the operating temperature.

The inventors have set themselves the objective of improving the endurance of the tire by optimizing the hoop reinforcement in order to reduce the mass and therefore lower the operating temperature thereof.

This objective has been achieved by a tire for a heavy-duty vehicle of construction plant type, comprising:
a crown reinforcement, radially on the inside of a tread and radially on the outside of a carcass reinforcement;
the crown reinforcement comprising a protective reinforcement, a working reinforcement and a hoop reinforcement;
the protective reinforcement, which is radially outermost in the crown reinforcement, comprising at least one protective layer, which is contains metal reinforcers that form an angle at least equal to 10° with a circumferential direction tangential to the circumference of the tire;
the working reinforcement comprising at least two working layers, each containing metal reinforcers that form an angle at least equal to 15° and at most equal to 45° with a circumferential direction of the tire and are crossed from one working layer to the next;
said working reinforcement having an axial width LT equal to the axial width of the widest working layer;
the hoop reinforcement comprising at least two radially overlaid hooping layers, each comprising metal reinforcers that form an angle at most equal to 2.5° with the circumferential direction, and are coated in an elastomeric compound;
said hoop reinforcement comprising an axially continuous first hooping layer and an axially discontinuous second hooping layer;
the first hooping layer having an axial width LF1 at least equal to 25% and at most equal to 75% of the axial width LT of the working reinforcement;
the discontinuous second hooping layer consisting of two hooping strips that are symmetrical with respect to an equatorial plane of the tire passing through the middle of the tread and perpendicular to the axis of rotation of said tire;
each hooping strip extending axially from an axially interior end as far as an axially exterior end over an axial width LF2 at least equal to 10% and at most equal to 35% of the axial width LF1 of the first hooping layer;
the distributed tension at break TR of each hooping strip, defined as being the product of the number D of reinforcers per mm times the force at break FR of each reinforcer expressed in daN, being at least equal to 100 daN/mm.

The main idea behind the invention is to have optimized hooping which, while satisfying the expected mechanical functions, does not have an adverse effect on the economical cost of manufacture of the tire.

The hooping needs to allow the tire:
To absorb shocks and reduce the depth of cuts in the tread when the tire runs over large stones;
To replace the design solutions of the prior art, such as described for example in documents WO 2014048897, and WO 2014095957, in which the crown is reinforced with narrow layers comprising reinforcers that make angles of between 6° and 12° with respect to the circumferential direction. What is meant by hooping layers that are narrow is layers having an axial width less than 0.6 times the width of the radially innermost working layer. Replacing the crossed layers of these conventional solutions with hooping layers makes it possible to eliminate shear in the meridian plane that divides these crossed layers into two when the tire is running under very heavy load.
To improve the endurance of the crown block by increasing the angles that the reinforcers of the working layers make with the circumferential direction
To reduce the materials cost of the tires in comparison with solutions not involving hooping.

The inventors have found that the hoop reinforcement performs these functions even if it is reduced to an axially continuous first hooping layer and an axially discontinuous second hooping layer. A second hooping layer said to be discontinuous means that the layer is restricted to a portion of the axial width of the crown comprised between around 20 mm and 100 mm. The central part of the second hooping layer under the crown is therefore eliminated in order to improve the production cost of the tire, without adversely affecting the performance thereof. The idea is to hoop the shoulder of the tire comprised between each sidewall and the tread in order to limit deformations at the free ends of the crown layers. The nature of the reinforcers and the rubber with which the reinforcers are coated need to be suitable for achieving sufficient hooping at the shoulder.

According to the invention, the first hooping layer has an axial width LF1 at least equal to 25% and at most equal to 75% of the axial width LT of the working reinforcement, and the discontinuous second hooping layer is made up of two hooping strips that are symmetrical with respect to an equatorial plane of the tire passing through the middle of the tread and perpendicular to the axis of rotation of said tire.

The width of the first hooping layer is expressed as a function of the width of the first working layer, which is itself dependent on the nominal width of the tire. The working width of the first hooping layer needs to be defined so as to ensure correct operation of the invention. For example, on a tire size such as 59/80R63, the widths of the first working layer and hooping layer are respectively 1034 mm, and 520 mm. On another, smaller, size such as 40.00R57, the widths of the first working layer and hooping layer are respectively 728 mm, and 360 mm. The invention can therefore be read across to an entire family of sizes such as, for example, from the size 59/80R63 to the size 40.00/R57.

Again according to the invention, each hooping strip extends axially from an axially interior end as far as an axially exterior end over an axial width LF2 which is at least equal to 10% and at most equal to 35% of the axial width LF1 of the first hooping layer;

The width LF2 of the hooping strip needs to be adapted to suit each size of tire. This width is dependent on the density of reinforcers in the hooping layer, and on the force at break of the reinforcer. For the one same given tire size, the lower the force at break for the reinforcer, the greater the density of reinforcers le, and therefore the width LF2.

On a size such as 40.00/R57, the width of the hooping strip needs to be equal to at least 90 mm, whereas on a larger size such as 59/80R63, the width of the hooping strip is 65 mm.

In the prior art, as described for example in patent application FR3044593A1, the two hooping layers are obtained by a circumferential wrapping of at least two turns of a ply radially on the outside of the first working layer. The circumferential distance between the first and second circumferential ends of the hoop reinforcement, which overlap, is at least equal to 0.6 m and at most equal to 1.2 m. In the region of overlap delimited by the first and second circumferential ends of the hoop reinforcement, the hoop reinforcement therefore comprises three hooping layers, and outside of this region, it comprises only two. This difference in thickness in the radial direction leads to non-uniformities which carry a penalty in the use of the tire. These non-uniformities cause the tire to be out-of-round and to bounce during running.

The solution offered by the inventors limits the second hooping layer only at the axial ends of the hoop reinforcement over a distance LF2 of 20 mm to 100 mm Thus, unlike in the prior art, the region of overlap of the two hooping strips extends only across the width LF2, rather than being spread across the entire width of the crown. This results in improved uniformity of the tire against the out-of-round and bounce criteria.

The two strips of the second hooping layer provide the crown with stiffness at the shoulders of the tire. The inventors have found that the tension absorbed by the hoop reinforcement in the central region of the crown is very small compared with the tension absorbed in the plies at the shoulders of the tire. Thus, by eliminating the central part of the second hooping layer, the advantages are combined, namely the improvement to the uniformity and the reduction of the mass of the tire, and therefore of its industrial production cost, without impacting on the endurance performance.

Furthermore, for correct operation of the hoop reinforcement, the distributed tension at break TR of each hooping strip, defined as being the product of the number D of reinforcers per millimetre times the force at break FR of each reinforcer expressed in daN, is at least equal to 100 daN/mm.

The inventors propose suitable sizing of the discontinuous hooping layer for correct operation of the invention. The distributed tension in the circumferential direction at least equal to 100 daN/mm ensures a sufficient level of stiffness at the ends of the crown reinforcement to limit deformation.

The inventors are proposing, for example, multistrand ropes of structure 1×N, comprising a single layer of N strands wound in a helix, each strand comprising an internal layer of M internal threads wound in a helix and an external layer of P external threads wound in a helix around the internal layer.

According to a first embodiment of the multistrand ropes, N=3 or N=4, preferably N=4. Preferably, the reinforcer is defined with 4 strands, but the option with 3 strands is equally suitable.

According to a second embodiment of the multistrand ropes, M=3, 4 or 5, preferably M=3.

According to a third embodiment of the multistrand ropes, wherein P=7, 8, 9, 10 or 11, preferably P=8.

These reinforcers are designed so as to obtain significant elongation under low tensile stress loads. The preferred choice results in reinforcers of the type: 4×(3+8)×0.35, i.e. ropes comprising 44 threads with an individual diameter of each thread equal to 35 hundredths of a millimetre. The use of such reinforcers improves the endurance of the tires by increasing the resistance to tensile stresses when passing over obstacles.

The invention is not limited to the previously studied reinforcers. Other assemblies are possible such as, for example, the 3×(1+6)×0.28 rope, which has 21 threads with an individual diameter of 28 hundredths of a millimetre. The diameter of such a rope is 1.9 mm and its breaking force is 250 daN.

Advantageously, the hoop reinforcement is positioned radially on the inside of the protective reinforcement.

By design, the protective reinforcement is positioned radially on the inside of the tread and in contact therewith. In the case of a tire for a heavy-duty vehicle of construction plant type that is intended to run over uneven ground, the presence of a protective reinforcement comprising at least one protective layer is advantageous. It essentially protects the working layers from mechanical or physicochemical attack, likely to spread through the tread radially towards the inside of the tire. In the case of multiple protective layers, it is advantageous for the reinforcers to be crossed from one layer to the next.

As a preference, the first hooping layer is positioned radially on the outside of the radially innermost working layer, and the second hooping layer is positioned radially on the outside of the first hooping layer and in contact therewith.

The inventors have demonstrated that the radial positioning of the hoop reinforcement in the crown reinforcement is dependent on the mechanical effects being sought. The crown reinforcement is a stack of layers formed by metal reinforcers coated in an elastomeric compound. Mechanically, the crown reinforcement can be likened to a multilayer beam having different bending stiffnesses which are dependent on the tensile elastic modulus values for the reinforcers used in the layers, and on the thicknesses of each layer. The inflated tire, mounted on its rim, is flattened by the load being carried. The deformation of the tire as a result of it being flattened by the load being carried is dependent on the distribution of the stiffnesses and thicknesses of the working layer around the neutral axis. The positioning of the hoop reinforcement aims to make it easier for the tire to flatten by reducing the deformations of the ends of the layers of the crown.

One preferred embodiment of the invention is therefore to position the hoop reinforcement on the inside of the working reinforcement, which is to say that the first hooping layer is laid on the first working layer and the two hooping strips are then laid on said first hooping layer.

Indeed, such an architecture allows, by virtue of the use of circumferential reinforcers located close to the neutral axis of the crown, the deformation of the crown to be limited to the shoulders of the tire. This therefore makes it possible to obtain both good endurance performance with regard to cleavage of the crown and good impact resistance performance by virtue of a crown that is flexible at the centre and is able to tolerate the deformation due to impacts when the vehicle drives over obstacles. Specifically, when passing over an obstacle, the crown of the tire acts as a beam, the neutral axis of which is located between the working layers depending on the type of deformation that is imposed. The neutral bending axis of the crown reinforcement is located between the stiffest crown layers, i.e. between the working layers. By positioning the circumferential reinforcers between said layers of the working layers, the solution minimizes the stresses, and the bending deformations associated with this stress, that the circumferential reinforcers must tolerate.

In a second embodiment of the invention, the second hooping layer is positioned radially on the outside of the second working layer and in contact therewith.

In this embodiment, the first hooping layer is laid on the carcass reinforcement over an axial width LF1. The second hooping layer, formed of two strips of a width of 30 mm to 100 mm, is laid on the second working layer and is therefore not in contact with said first hooping layer.

In a third embodiment of the invention, the second hooping layer is positioned radially on the outside of the carcass reinforcement and in contact therewith.

For certain sizes of tire, depending on the choice of reinforcers for the crown layers, and on the thickness thereof, it may be advantageous to have the hooping strips laid directly on the carcass reinforcement. In such cases, the continuous hooping layer is laid on the first working layer.

In the manufacture of the hoop reinforcement it is possible to use either plies cut directly to the desired width, or else thin strips of a width of 35 mm to 252 mm, formed of metal reinforcers coated in an elastomeric compound, and laid contiguously until the desired width is obtained.

According to one advantageous embodiment of the invention, the first hooping layer is made up of a circumferential winding of a ply of metal reinforcers.

The ply of metal reinforcers is initially stored on a reel. Then, it is unwound and laid by being circumferentially wound radially on the outside of the tire layers that are already radially stacked. The ply of metal reinforcers is wound over a full turn so as to create a continuous hooping layer. The starting end for winding and the end at the end of winding are offset so that the hoop reinforcement comprises two layers of hooping over only a limited circumferential distance or length of overlap. The length of overlap varies from 0.6 m to 1.2 m.

According to another embodiment of the invention, it is advantageous for each hooping strip of the second hooping layer to consist of a circumferential winding of a ply of metal reinforcers.

For the second hooping layer, a hooping ply is cut to a width equal to that of the hooping strip. The length of the cut ply is such that it can make a full circumferential turn around the layers that have already been stacked radially, overlapping the starting end by a length of 0.6 to 1.2 m. In order to limit the impact this has on the uniformity of the tire, the regions of overlap of the first and second hooping layers are offset in the circumferential direction.

In another embodiment of the invention, the first hooping layer is made up of an axial juxtaposition of contiguous turns of a thin strip, wound circumferentially, said thin strip comprising at least 8 and at most 30 consecutive metal reinforcers which are mutually parallel and coated in an elastomeric compound.

The first hooping layer is then obtained by helical winding that is contiguous, in the axial direction, of a thin strip, radially on the outside of the layers of the tire that have already been stacked radially. The advantage with this embodiment lies in the absence of a region of overlap that leads to a local overthickness that is detrimental to the uniformity of the tire.

Each strip of the second hooping layer is also advantageously made up of an axial juxtaposition of contiguous turns of a thin strip, wound circumferentially, said thin strip comprising at least 8 and at most 30 consecutive metal reinforcers which are mutually parallel and coated in an elastomeric compound.

For this embodiment of the invention, each strip of the second hooping layer is made up of the winding of contiguous turns of a thin strip over a length equal to the width LF2 of the strip. In this way, the region delimited by the two axially interior ends of the two strips constitutes a region without hooping. In this embodiment, there is no overlapping of the starting end of the hooping strip either.

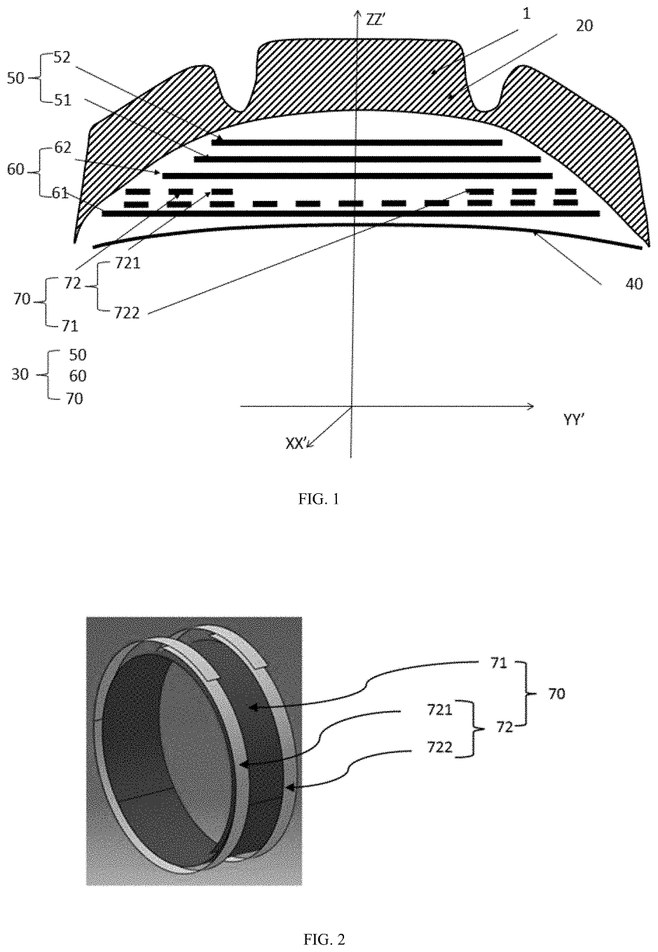

The invention is illustrated in FIGS. 1 to 8, which are not shown to scale for the sake of understanding.

FIG. 1 shows a meridian section through the crown of a tire 1 according to the invention, comprising:
A carcass reinforcement 40 made up of a single carcass layer, the reinforcers of which form an angle close to 90°, which is to say comprised between [85°, 95°] with the circumferential direction XX;
A working reinforcement 60 radially on the outside of the carcass reinforcement 40 and comprising two working layers 61 and 62. The radially innermost working layer 61 has an axial width LT greater than that of the second working layer 62;
A protective reinforcement 50 radially on the outside of the working reinforcement 60 and radially on the inside of the tread 20 and comprising two protective layers 51 and 52;
A hoop reinforcement 70 comprising a continuous first layer 71 extending over an axial width LF1, and a discontinuous second layer formed of two strips 721 and 722, each having an axial width LF2. In the case depicted, the hoop reinforcement 70 is positioned radially between the two working layers (61, 62);
A tread 20;
The working 60, protective 50 and hoop 70 reinforcements constituting the crown reinforcement 30.

FIG. 2 depicts a perspective view of the hoop reinforcement 70 that forms the subject of the invention, with a continuous first hooping layer 71, and a discontinuous second hooping layer made up of two strips 721, 722 which are symmetrical about an equatorial plane passing through the centre of the tire.

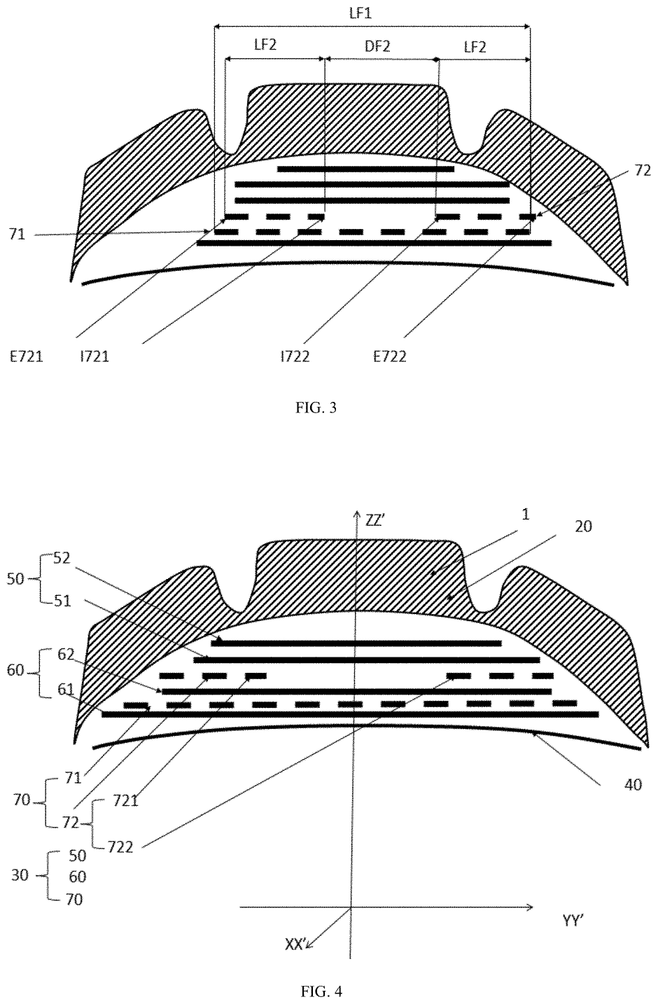

FIG. 3 shows a meridian section through the crown of a tire according to the invention, marking the characteristic dimensions of the invention:
The axial width LF1 is the measurement of the axial width of the first hooping layer. Said axial width is expressed as a proportion of that of the first working layer LT (not depicted);
The second hooping layer comprising two hooping strips 721 and 722 which are symmetrical about the equatorial plane, the strip 721 (and respectively 722) having an axially exterior first end E721 (and respectively E722) and an axially interior second end I721 (and respectively I722), the axial width of the hooping strip LF2 is the axial distance between the ends E721 and I721. The axial width DF2 measures the distance between the respective axially interior ends I721 and I722 of the two hooping strips 71 and 72 and therefore the axial width of the discontinuity.

FIG. 4 depicts a meridian section through the crown of a tire according to the invention according to one embodiment of the invention in which the first hooping layer 71 is radially on the outside of the first working layer 61. The two hooping strips (721; 722) that form the layer 72 are radially on the outside of the second working layer 62.

FIG. 5 depicts a meridian section through the crown of a tire according to the invention according to another embodiment of the invention in which the two hooping strips (721; 722) are radially on the outside of the carcass reinforcement 40. The hooping layer 71, for its part, is radially on the outside of the first working layer 61.

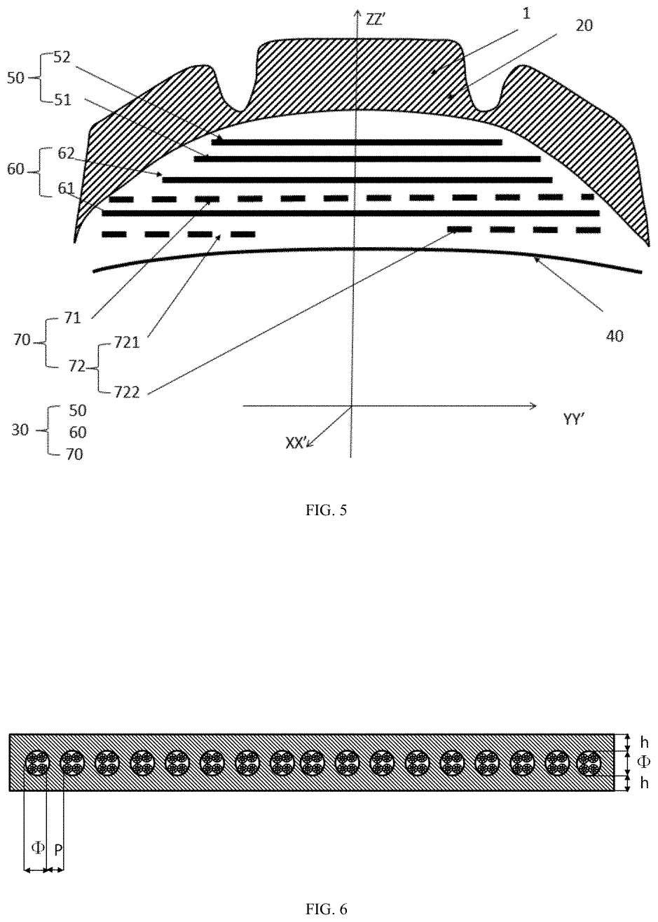

FIG. 6 depicts a hooping layer with reinforcers having a diameter Φ, that can vary between 1.9 mm and 3.8 mm, distributed at a spacing P and coated in a coating rubber of thickness h on the back of the upper reinforcer or equal to 0.6 mm.

A hooping layer of the crown reinforcement of the tire is obtained either by the circumferential winding of a ply as depicted in FIG. 6, or as an axial juxtaposition of contiguous turns of a thin strip, wound circumferentially, said thin strip comprising at least 8 and at most 30 consecutive metal reinforcers which are mutually parallel and coated in an elastomeric compound.

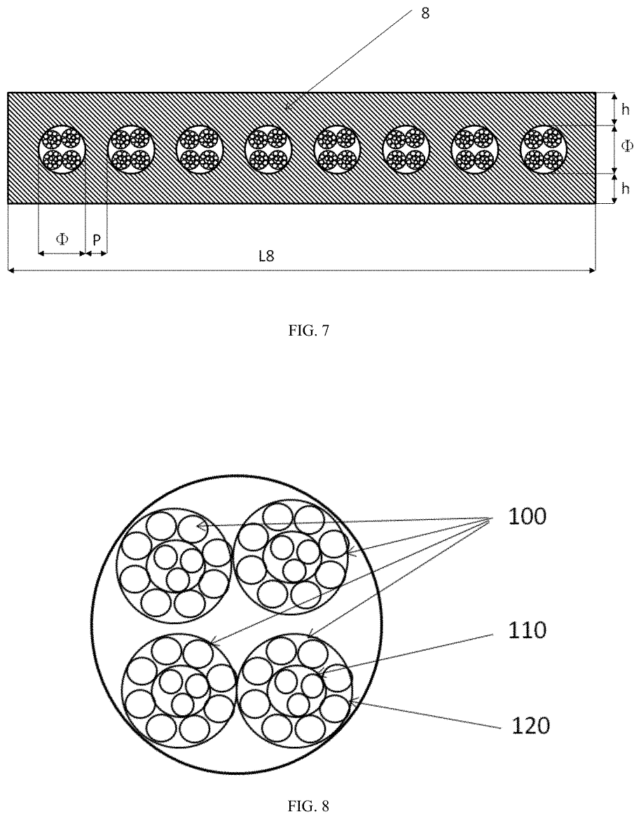

FIG. 7 depicts a thin strip 8 as described previously, comprising 8 consecutive metal reinforcers that are mutually parallel and coated in an elastomeric compound.

The width L8 of the thin strip depends on the diameter Φ of a reinforcer and on the spacing P between two consecutive reinforcers. Typically, the width L8 is defined for a number of reinforcers ranging from 8 to 30, with a spacing P that can range from 2.5 mm to 4.4 mm. The width L8 of the thin strip can range from 35 to 252 mm.

FIG. 8 depicts one reinforcer of the hooping layer. Said reinforcer is a collection of 4 strands 100, each one made up of an internal layer 110 of 3 threads and of an external layer 120 of 8 threads.

The invention was implemented on a 59/80R63 sized tire for a heavy-duty vehicle of construction plant type. The tire according to the invention differs from the reference tire in terms of the hoop reinforcement. For the reference tire, the hoop reinforcement is obtained by the circumferential winding of a ply radially on the outside of the first working layer 61, extending from a circumferential first end as far as a circumferential second end, so as to form a radial stack of at least two hooping layers. For the invention, the tire is manufactured in accordance with FIG. 1, in which the second hooping layer is formed of the two hooping strips 721 and 722, as depicted in FIG. 2. The axially interior ends of the two hooping strips are distant by a length DF2.

For the tire size 59/80R63 being studied, the geometric features of the hoop reinforcement are given in Table 1 below:

TABLE 1

| | | | Axial distance |
|---|---|---|---|
| | | Axial width | DF2 between |
| | | LF2 of each | the two hooping |
| Axial width LT | Axial width LF1 | hooping strip of | strips of the 2^{nd} |
| of the 1^{st} working | of the 1^{st} hooping | the 2^{nd} hooping | hooping layer |
| layer (mm) | layer (mm) | layer (mm) | (mm) |
| 1034 | 520 | 65 | 390 |

The calculations simulating running of the tire were conducted on the tire size 59/80R63 for a supported load of 104 tonnes, with an inflation pressure of 7 bar. Furthermore, the tire was subjected to a cornering force of 26 tonnes.

The results of the finite-element calculations show that the shear deformations in the meridian and circumferential planes are of the same order of magnitude for the reference tire and the tire of the invention:

TABLE 2

| | Maximum | Maximum |
|---|---|---|
| | amplitude of | amplitude of |
| | shear in the | shear in the |
| | meridian | circumferential |
| | plane | plane |
| Reference: Tire | 0.8 | 0.27 |
| with both of the | | |
| two hooping | | |
| layers continuous | | |
| across the entire | | |
| width of the | | |
| crown | | |
| Tire of the | 0.81 | 0.27 |
| invention: second | | |
| hooping layer | | |
| discontinuous | | |

This result confirms that the absence of hooping at the centre of the tread does not adversely affect the endurance of the tire.

The tire produced in accordance with the invention has a mass lower than that of the reference tire, as illustrated in the following table:

TABLE 3

| | Mass in base 100 |
|---|---|
| Reference: Tire with both | 100 |
| of the two hooping layers | |
| continuous across the | |
| entire width of the crown | |
| Tire of the invention: | 155 |
| second hooping layer | |
| discontinuous | |

The mass of the hoop reinforcement is 55% lower than that of the reference tire.

Eliminating the hooping layer over a distance DF2 of 390 mm has also improved the thermodynamics of the tire. In the equatorial plane that passes through the centre of the tire, above the second protective layer, the temperature has dropped by 5°.

1. A tire for a heavy-duty vehicle of construction plant type, comprising:
a crown reinforcement, radially on the inside of a tread and radially on the outside of a carcass reinforcement;
the crown reinforcement comprising a protective reinforcement, a working reinforcement and a hoop reinforcement;
the protective reinforcement, which is radially outermost in the crown reinforcement, comprising at least one protective layer, the protective layer comprising metal reinforcers that form an angle at least equal to 10° with a circumferential direction (XX′) tangential to the circumference of the tire;
the working reinforcement comprising at least two working layers, each working layer comprising metal reinforcers that form an angle at least equal to 15° and at most equal to 45° with the circumferential direction (XX′) and are crossed from one working layer to the next;
said working reinforcement having an axial width LT equal to the axial width of the widest working layer;
the hoop reinforcement comprising at least two hooping layers, each made up of metal reinforcers that form an angle at most equal to 2.5° with the circumferential direction (XX), and are coated in an elastomeric compound;
wherein the hoop reinforcement comprises an axially continuous first hooping layer and an axially discontinuous second hooping layer, in that the first hooping layer has an axial width LF1 at least equal to 25% and at most equal to 75% of the axial width LT of the working reinforcement, in that the discontinuous second hooping layer consists of two hooping strips that are symmetrical with respect to an equatorial plane (XZ) of the tire passing through the middle of the tread and perpendicular to the axis of rotation (YY′) of said tire, in that each hooping strip extends axially from an axially interior end as far as an axially exterior end over an axial width LF2 which is at least equal to 10% and at most equal to 35% of the axial width LF1 of the first hooping layer, and in that the distributed tension at break TR of each hooping strip, defined as being the product of the number D of reinforcers per mm times the force at break FR of each reinforcer expressed in daN, is at least equal to 100 daN/mm.

2. The tire according to claim 1, wherein the hoop reinforcement is positioned radially on the inside of the protective reinforcement.

3. The tire according to claim 1, wherein the first hooping layer is positioned radially on the outside of the radially innermost working layer.

4. The tire according to claim 3, wherein the second hooping layer is positioned radially on the outside of the first hooping layer and in contact therewith.

5. The tire according to claim 3, wherein the second hooping layer is positioned radially on the outside of the second working layer and in contact therewith.

6. The tire according to claim 3, wherein the second hooping layer is positioned radially on the outside of the carcass reinforcement and in contact therewith.

7. The tire according to claim 1, wherein the first hooping layer is made up of a circumferential winding of a ply of metal reinforcers.

8. The tire according to claim 1, wherein each hooping strip of the second hooping layer is made up of a circumferential winding of a ply of metal reinforcers.

9. The tire according to claim 1, wherein the first hooping layer is made up of an axial juxtaposition of contiguous turns of a thin strip, wound circumferentially, said thin strip comprising at least 8 and at most 30 consecutive metal reinforcers which are mutually parallel and coated in an elastomeric compound.

10. The tire according to claim 1, wherein each hooping strip of the second hooping layer is made up of an axial juxtaposition of contiguous turns of a thin strip, wound circumferentially, said thin strip comprising at least 8 and at most 30 consecutive metal reinforcers which are mutually parallel and coated in an elastomeric compound.
